(19) United States
(12) Patent Application Publication
(10) Pub. No.: US 2015/0326834 A1
(43) Pub. Date: Nov. 12, 2015

(54) WALL DISPLAY SYSTEM

(71) Applicant: SAMSUNG DISPLAY CO., LTD., Yongin-si (KR)

(72) Inventor: Min-Joo Park, Seoul (KR)

(21) Appl. No.: 14/466,859

(22) Filed: Aug. 22, 2014

(30) Foreign Application Priority Data
May 8, 2014 (KR) 10-2014-0054829

(51) Int. Cl. H04N 7/18; H04N 5/232

(52) U.S. Cl. CPC H04N 7/183; H04N 5/23293; H04N 5/23216

(57) ABSTRACT

A wall display system includes a display unit mounted on the entire surface of a wall or a part of the wall surface, the display unit being configured to reproduce sound or images; a camera and microphone configured to detect motion and sound of a user, respectively; and a controller configured to receive image signals and sound signals output from the camera and microphone, respectively, and to transmit the image signals to the display unit.

### CROSS-REFERENCE TO RELATED APPLICATION

This application claims priority to and the benefit of Korean Patent Application No. 10-2014-0054829, filed on May 8, 2014, in the Korean Intellectual Property Office, the disclosure of which application is incorporated herein in its entirety by reference.

### BACKGROUND

1. Field

Embodiments of the inventive concept relate to a wall display system including a display unit mounted on the entire surface of a wall or a part of the wall surface.

2. Description of Related Technology

Display technologies have come a long way in recent years and commercially available display devices have been enlarged in size. A wall display system may include a tiled display which is composed of a plurality of display devices whose images are displayed side-by-side to create a tiled mosaic of imagery. In a tiled display, each of the plurality of display devices displays a part of the entire image which is desired to be represented.

There are various types of display devices such as flat panel displays, e.g., liquid crystal displays (LCDs), organic light emitting diodes (OLEDs), and plasma display panels (PDPs) in order to realize a conventional large size wall display system.

With recent home video cameras that have been widely provided, content can be produced by individuals or small groups and the home video cameras can be applied to a variety of areas. For instance, the home video cameras can be used to record children's daily life in the form of pictures or videos. The pictures or videos can be edited by the service provider or family members to memorize the daily life of children in the form of pictures or videos. However, it is difficult to get natural and unaffected pictures or videos of family life at home by the home video cameras. This is because one of the family members need to operate the camera, and thus is excluded from a picture or video, or all family members are aware of being taken pictures, and thus they act unnaturally before the camera.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding effective filing dates of subject matter disclosed herein.

### SUMMARY

Aspects of embodiments of the inventive concept are directed to a wall display system that is capable of recording family's everyday life or children's growth at home unaffectedly and of being used in various ways.

According to one embodiment, a wall display system includes: a display unit mounted on the entire surface of a wall or a part of the wall surface and configured to reproduce sound or images; a camera and microphone configured to detect motion and sound of a user, respectively; and a controller configured to receive image signals and sound signals output from the camera and microphone, respectively, and to transmit the image signals to the display unit.

The controller may operate the display unit and the microphone according to the image signals output from the camera.

The controller may operate the display unit and the camera accoding to the sound signals output from the microphone.

The wall display system may further include a storage unit configured to store the image signals and sound signals output from the camera and microphone.

The controller may simultaneously output image data or sound data, which is stored at different times to the display unit.

The controller may simultaneously output previously input image data or sound data stored in the storage unit and current input image data or sound data to the display unit.

The wall display system may further include a communication unit configured to connect the controller to a smart device in a wired or wireless manner.

The controller may output image data or sound data input from the smart device through the communication unit to the display unit.

The display unit may include: a substrate; a driving circuit unit on the substrate; a display element unit on the driving circuit unit; a sealing member on the display element unit; and a touch screen panel disposed on at least one of the substrate and the sealing member.

The controller may operate the display unit utilizing a touch signal input through the touch screen panel.

The substrate may include any one of glass, tempered glass, and transparent plastic.

The transparent plastic may include at least one material selected from the group consisting of Kapton®, polyethersulphone (PES), polycarbonate (PC), polyimide (PI), polyethyleneterephthalate (PET), polyethylenenaphthalate (PEN), polyacrylate (PAR), and fiber reinforced plastic (FRP).

The driving circuit unit may include a thin film transistor layer.

The thin film transistor layer may include an oxide semiconductor.

The thin film transistor layer may include a transparent electrode material.

The transparent electrode material may include a transparent conducting oxide (TCO).

The transparent conducting oxide (TCO) may include at least one selected from the group consisting of indium tin oxide (ITO), indium zinc oxide (IZO), antimony tin oxide (ATO), aluminum zinc oxide (AZO), zinc oxide (ZnO), and mixtures thereof.

The display element unit may include an organic light emitting diode.

According to embodiments of the inventive concept, a wall display system is capable of recording family's everyday life or children's growth at home unaffectedly and of being used in various ways.

The foregoing is illustrative only and is not intended to be in any way limiting the scope of the inventive concept. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the inventive concept will be more clearly understood from the following detailed description taken in conjunction with the accompanying drawings, in which:

FIG. 1 is a schematic block diagram illustrating a wall display system according to an embodiment of the inventive concept;

FIG. 2 is a schematic concept diagram illustrating a wall display system according to an embodiment of the inventive concept;

FIG. 3 is a partially enlarged view of part “A” of FIG. 2;

FIG. 4 is a cross-sectional view taken along line I-I′ of FIG. 3; and

FIGS. 5 and 6 provide examples of application of a wall display system according to an embodiment of the inventive concept.

### DETAILED DESCRIPTION

Hereinafter, embodiments of the inventive concept are described with reference to the accompanying drawings.

Example embodiments of the inventive concept are illustrated in the accompanying drawings and described in the specification. The scope of the inventive concept is not limited to the example embodiments and should be construed as including all potential changes, equivalents, and substitutions to the example embodiments.

In the specification, when a first element is referred to as being “connected” to a second element, the first element may be directly connected to the second element or indirectly connected to the second element with one or more intervening elements interposed therebetween. The terms “comprises,” “comprising,” “includes,” and/or “including,” when used in this specification, may specify the presence of stated features, integers, steps, operations, elements, and/or components, but do not preclude the presence or addition of one or more other features, integers, steps, operations, elements, and/or components.

Although the terms “first,” “second,” and “third” and the like may be used herein to describe various elements, these elements should not be limited by these terms. These terms may be used to distinguish one element from another element. Thus, “a first element” could be termed “a second element” or “a third element,” and “a second element” and “a third element” can be termed likewise without departing from the teachings herein. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-type (or first-set),” “second-type (or second-set),” etc., respectively.

Like reference numerals may refer to like elements in the specification.

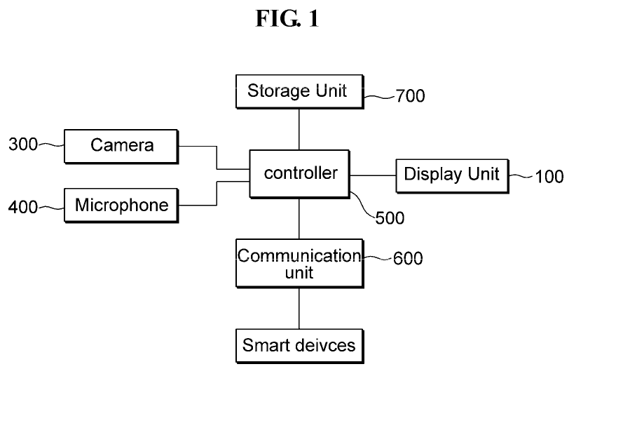

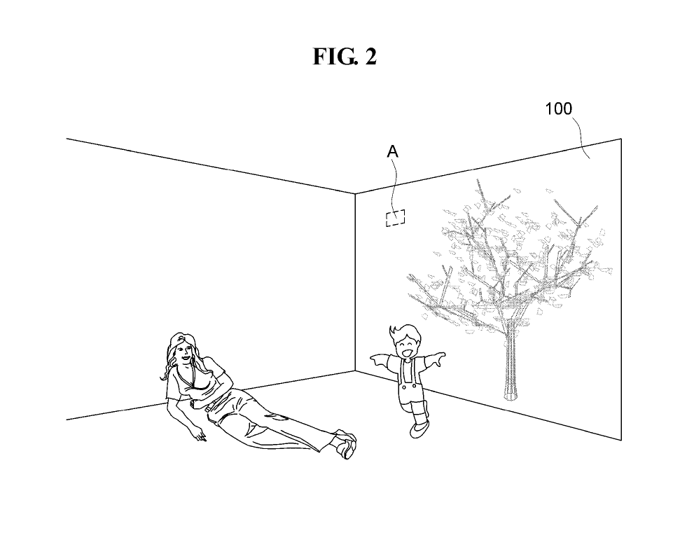

FIG. 1 is a schematic block diagram illustrating a wall display system according to an embodiment of the inventive concept. FIG. 2 is a schematic concept diagram illustrating a wall display system according to an embodiment of the inventive concept.

Referring to FIGS. 1 and 2, a wall display system according to one embodiment includes a display unit 100 mounted on the entire surface of a wall or a part of the wall surface and configured to reproduce images or sound, at least one camera 300 and at least one microphone 400 configured to detect motion or sound of a user, respectively, and a controller 500 allowing the display unit 100, the camera 300, and the microphone 400 to be operated using image signals and sound signals input from the camera 300 and the microphone 400.

The display unit 100 may include a first substrate, a driving circuit unit on the first substrate, a display element unit on the driving circuit unit, a second substrate on the display element unit, and a touch screen panel on at least one substrate of the first and second substrates.

The wall display system according to one embodiment may further include a communication unit 600 linked with a smart device in a wired or wireless manner and a storage unit 700 configured to store image signals and sound signals input to the camera 300 and the microphone 400.

The display unit 100 may be mounted on the whole surface of a wall or a part of the wall surface. The display unit 100 may be provided by utilizing one display device or utilizing a plurality of display devices as a tiled display. In the case where the display unit 100 is provided with a plurality of display devices, partial images forming the whole image intended to be represented may be displayed in each display device. Hereinafter, the display unit 100 will be described as having one display device.

Further, the display unit 100 may be any one of a liquid crystal display (LCD), an organic light emitting diode (OLED), a plasma display panel (PDP), and the like. A configuration of the display unit 100 will be described below in detail.

At least one camera 300 may be provided and may be disposed on a wall surface on which the display unit 100 is mounted or on a wall surface facing the wall surface on which the display unit 100 is mounted. The camera 300 may be integrated in the display unit 100. The camera 300 according to one embodiment may be an infrared camera and may detect user's motions, etc. even when no ambient light is present.

The motions of a user that may be detected by the camera 300 may include gestures such as, for example, movement of the hands, face, or other parts of the body and eye blinking. The camera 300 may detect the motions of a user, compare the detected motions with a preset command action, and turn on or off functions of the display unit 100, the camera 300, the microphone 400, and the like.

In other words, the camera 300 may respond to a preset motion while detecting user's motions, and may turn on or off functions of the camera 300 (e.g., photographs or moving images such as movies) or may turn on or off functions of the microphone 400 (e.g., recording sound such as voice).

Similarly, at least one microphone 400 may be provided and may be integrated in the display unit 100. The microphone 400 may detect audio signals of a user, compare the detected audio signals with a preset voice command signal, and turn on or off functions of the display unit 100, the camera 300, the microphone 400, and the like.

In other words, the microphone 400 may respond to a preset voice command signal while detecting user's voice signals, and may turn on or off functions of the camera 300 (e.g., photographs or moving images such as movies) or may turn on or off functions of the microphone 400 (e.g., recording sound such as voice).

For instance, if a user says “shooting photos,” a voice command signal may be input through the microphone 400 and the controller 500 receiving the voice command signal may switch the display unit 100 and the camera 300 to a shooting mode. When the shooting mode is conducted, the user may shoot photos utilizing gestures or voice command signals while seeing images on the display unit 100.

The controller 500 may be connected to the communication unit 600 linked with a smart device in a wired or wireless manner. The controller 500 may also output image or sound signals input from the smart device through the communication unit 600 to the display unit 100. The smart device may include, but not limited to, a smartphone, a tablet PC, and a smart TV.

The storage unit 700 may store software for driving the controller 500 and may also store image data (e.g., photographs or videos) and sound data (recorded files) input through the camera 300 and the microphone 400. In addition, image data and sound data input from the smart device through the communication unit 600 may be stored in the storage unit 700. Further, the storage unit 700 may store data such as a memo or an image file input by a user through a touch screen panel of the display unit 100, which will be described below.

The controller 500 may output image data and sound data stored at different times to the display unit 100 at the same time. The controller 500 may also output the previous image data and sound data stored in the storage unit 700 and current input image data and sound data to the display unit 100 at the same time. By virtue of the functions, a user may compare and appreciate the previous image data and sound data and the current image data and sound data.

In one embodiment, the camera 300, the microphone 400, the controller 500, the communication unit 600, the storage unit 700, and the like may be integrally formed with the display unit 100, or may be externally mounted so as to be attached to and detached from the display unit 100.

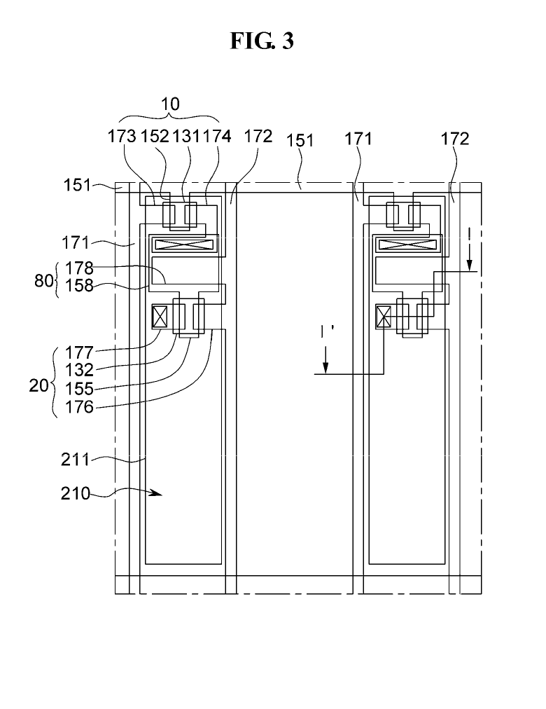

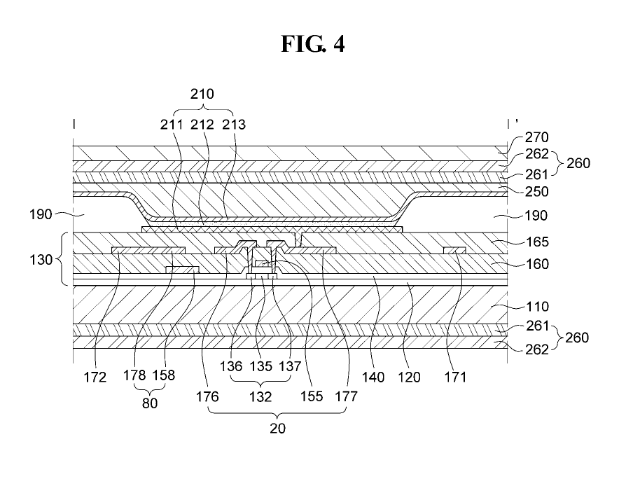

FIG. 3 is a partially enlarged view of part “A” of FIG. 2. FIG. 4 is a cross-sectional view taken along line I-I′ of FIG. 3.

Referring to FIGS. 3 and 4, the display unit 100 of the wall display system according to one embodiment may include a substrate 110, a driving circuit unit 130 on the substrate 110, a display element unit 210 on the driving circuit unit 130, and a sealing member 250 on the display element unit 210.

A coating layer 260 may be disposed on one surface of the substrate 110 and one surface of the sealing member 250. The coating layer 260 may include at least one of a water-proof coating layer and a heat-proof coating layer.

A touch screen panel 270 may be disposed on the coating layer 260.

The display element unit 210 may be any one of an organic light emitting diode (OLED), a liquid crystal display (LCD), and an electrophoretic display (EPD). Such display elements may include in common a thin film transistor (TFT). Hereinafter, the display element unit 210 including an OLED will be described.

The driving circuit unit 130 may be disposed on the substrate 110 so as to drive the display element unit 210. The driving circuit unit 130 may include a switching TFT 10, a driving TFT 20, and a capacitor 80, and may drive the OLED 210 serving as a display element.

Although the detailed structures of the driving circuit unit 130 and the OLED 210 are illustrated in FIGS. 3 and 4, embodiments of the inventive concept are not limited to FIGS. 3 and 4. The driving circuit unit 130 and the OLED 210 may be embodied in many different forms within a range in which those skilled in the art can easily excogitate.

In FIG. 3, one pixel may include two TFTs and a capacitor, but embodiments of the inventive concept are not limited thereto. One pixel may include three or more TFTs and two or more capacitors, and may further include signal lines. The wall display system according to one embodiment may have many different structures. Herein, the term “pixel” refers to the smallest unit for displaying an image.

Referring to FIGS. 3 and 4, every pixel may include a switching TFT 10, a driving TFT 20, a capacitor 80, and an OLED 210. The configuration including the switching TFT 10, the driving TFT 20, and the capacitor 80 is called the driving circuit unit 130.

The driving circuit unit 130 may further include a gate line 151 arranged along one direction, a data line 171 insulated from and intersecting (crossing) the gate line 151, and a common power supply line 172. One pixel is generally defined by the gate line 151, the data line 171, and the common power supply line 172, but may be defined differently. For example, the pixel may be defined by a black matrix or a pixel defining layer (PDL).

The substrate 110 may be a transparent insulating substrate made of glass, tempered glass, transparent plastic, or the like. In one embodiment, the substrate 110 may be made of at least one material selected from the group consisting of Kapton®, polyethersulphone (PES), polycarbonate (PC), polyimide (PI), polyethyleneterephthalate (PET), polyethylenenaphthalate (PEN), polyacrylate (PAR), and fiber reinforced plastic (FRP).

A buffer layer 120 may be disposed on the substrate 110. The buffer layer 120 may prevent infiltration of undesirable elements such as impurities or moisture, and may provide a planar surface. The buffer layer 120 may be made of a suitable material for planarizing and/or preventing infiltration. For example, the buffer layer 120 may include at least one selected from the group consisting of silicon nitride (SiNₓ), silicon oxide (SiO₂), and silicon oxynitride (SiOₓN_{y}). In an implementation, the buffer layer 120 may be omitted depending on kinds and manufacturing process conditions of the substrate 110.

A switching semiconductor layer 131 and a driving semiconductor layer 132 may be disposed on the buffer layer 120. The switching and driving semiconductor layers 131 and 132 may include at least one of polycrystalline silicon, amorphous silicon, and oxide semiconductors such as indium gallium zinc oxide (IGZO) and indium zinc tin oxide (IZTO). For instance, when the driving semiconductor layer 132 illustrated in FIG. 4 is made of polycrystalline silicon, the driving semiconductor layer 132 may include a channel area 135 that is not doped with impurities, and p+ doped source and drain areas 136 and 137 on the respective sides of the channel area 135. P-type impurities such as boron B may be used as dopant ions. B₂H₆ may be used to dope p+ doped source and drain areas 136 and 137. Such impurities may vary depending on the kinds of thin film transistors (TFTs). According to one embodiment, a PMOS-structured TFT using the p-type impurities is used as the driving TFT 20, but embodiments of the inventive concept are not limited thereto. An NMOS-structured TFT may also be used as the driving TFT 20. When using a plurality of driving TFT is used as a driving TFT, CMOS structured TFT may also be used as the driving TFT.

A gate insulating layer 140 may be disposed on the switching and driving semiconductor layers 131 and 132. The gate insulating layer 140 may include at least one selected from the group consisting of tetraethyl orthosilicate (TEOS), silicon nitride (SiNₓ), and silicon oxide (SiO₂). For instance, the gate insulating layer 140 may have a double layer structure in which a silicon nitride layer having a thickness of about 40 nm and a TEOS layer having a thickness of about 80 nm are sequentially laminated, but the structure of the gate insulating layer 140 is not limited thereto.

A gate wire including gate electrodes 152 and 155 may be disposed on the gate insulating layer 140. The gate wire may further include a gate line 151, a first capacitor plate 158, and other lines. The gate electrodes 152 and 155 may be disposed to overlap at least a part of the semiconductor layers 131 and 132 and, for example, to overlap the channel area 135. The gate electrodes 152 and 155 may prevent the channel area 135 from being doped with impurities when the source and drain areas 136 and 137 of the semiconductor layers 131 and 132 are doped with the impurities.

The gate electrodes 152 and 155 and the first capacitor plate 158 may be disposed on the same plane and may be made of substantially the same metal material. The gate electrodes 152 and 155 and the first capacitor plate 158 may include at least one selected from the group consisting of molybdenum (Mo), chromium (Cr), and tungsten (W).

An interlayer insulating layer 160 configured to cover the gate electrodes 152 and 155 may be disposed on the gate insulating layer 140. The interlayer insulating layer 160 may be made of tetraethyl orthosilicate (TEOS), silicon nitride (SiNₓ), or silicon oxide (SiOₓ) similar to the gate insulating layer 140, but embodiments of the inventive concept are not limited thereto.

A data wire including source electrodes 173 and 176 and drain electrodes 174 and 177 may be disposed on the interlayer insulating layer 160. The data wire may further include a data line 171, a common power supply line 172, a second capacitor plate 178, and other lines. The source electrodes 173 and 176 and the drain electrodes 174 and 177 may be respectively coupled to the source area 136 and the drain area 137 of the semiconductor layers 131 and 132 through a contact opening formed in the gate insulating layer 140 and the interlayer insulating layer 160.

Thus, the switching TFT 10 may include the switching semiconductor layer 131, the switching gate electrode 152, the switching source electrode 173, and the switching drain electrode 174, and the driving TFT 20 may include the driving semiconductor layer 132, the driving gate electrode 155, the driving source electrode 176, and the driving drain electrode 177. The configurations of the TFTs 10 and 20 are not limited to the above-described embodiment and may vary according to known configurations that can be carried out by those skilled in the art.

The capacitor 80 may include the first capacitor plate 158 and the second capacitor plate 178 with the interlayer insulating layer 160 interposed therebetween.

The switching TFT 10 may function as a switching device which selects a pixel to perform light emission. The switching gate electrode 152 may be coupled to the gate line 151. The switching source electrode 173 may be coupled to the data line 171. The switching drain electrode 174 may be spaced apart from the switching source electrode 173 and coupled to the first capacitor plate 158.

The driving TFT 20 may apply driving power to a pixel electrode 211, which allows a light emitting layer 212 of the OLED 210 in the selected pixel to emit light. The driving gate electrode 155 may be coupled to the first capacitor plate 158. The driving source electrode 176 and the second capacitor plate 178 may be coupled to the common power supply line 172. The driving drain electrode 177 may be coupled to the pixel electrode 211 of the OLED 210 through a contact hole.

With the above-described structure, the switching TFT 10 may be operated by a gate voltage applied to the gate line 151, and may function to transmit a data voltage applied to the data line 171 to the driving TFT 20. A voltage equivalent to a differential between a common voltage applied to the driving TFT 20 from the common power supply line 172 and the data voltage transmitted from the switching TFT 10 may be stored in the capacitor 80, and a current corresponding to the voltage stored in the capacitor 80 may flow to the OLED 210 through the driving TFT 20, so that the OLED 210 may emit light.

A planarization layer 165 may be configured to cover the data wire patterned on the same plane as the data line 171, the common power supply line 172, the source electrodes 173 and 176, the drain electrodes 174 and 177, the second capacitor plate 178, and the like that are disposed on the interlayer insulating layer 160.

The planarization layer 165 may serve to planarize a surface of the OLED 210 by eliminating or reducing steps so as to increase light emission efficiency of the OLED 210 that will be disposed on the planarization layer 165. The planarization layer 165 may be made of at least one selected from the group consisting of a polyacrylate resin, an epoxy resin, a phenolic resin, a polyamide resin, a polyimide resin, an unsaturated polyester resin, a polyphenylenether resin, a polyphenylene sulfide resin, and benzocyclobutene (BCB).

The pixel electrode 211 of the OLED 210 may be disposed on the planarization layer 165. The pixel electrode 211 may be coupled to the drain electrode 177 through a contact opening of the planarization layer 165.

A pixel defining layer (PDL) 190 configured to define a pixel area by exposing at least a part of the pixel electrode 211 may be disposed on the planarization layer 165. That is, the pixel electrode 211 may be disposed to correspond to a pixel area defined by the PDL 190. The PDL 190 may be made of a polyacrylate resin or a polyimide resin.

The light emitting layer 212 may be disposed on the pixel electrode 211 in the pixel area and a common electrode 213 may be disposed on the PDL 190 and the light emitting layer 212. The light emitting layer 212 may include a low molecular weight organic material or a high molecular weight organic material. At least one of a hole injection layer (HIL) and a hole transport layer (HTL) may be disposed between the pixel electrode 211 and the light emitting layer 212, and at least one of an electron transport layer (ETL) and an electron injection layer (EIL) may be disposed between the light emitting layer 212 and the common electrode 213.

The pixel electrode 211 and the common electrode 213 may be any one of a transmissive electrode, a transflective electrode, and a reflective electrode.

A transparent conductive oxide (TCO) may be used to form the transmissive electrode. The TCO may include at least one selected from the group consisting of indium tin oxide (ITO), indium zinc oxide (IZO), antimony tin oxide (ATO), aluminum zinc oxide (AZO), zinc oxide (ZnO), and mixtures thereof.

A metal such as magnesium (Mg), silver (Ag), gold (Au), calcium (Ca), Lithium (Li), Chromium (Cr), aluminum (Al), and copper (Cu), or alloys thereof may be used to form the transflective electrode and the reflective electrode. In this case, whether to be the transflective electrode or the reflective electrode may be determined by thickness of the electrode. In general, the transflective electrode has a thickness of about 200 nm or less and the reflective electrode has a thickness of about 300 nm or greater. As the thickness of the transflective electrode becomes thinner, light transmittance increases, but resistance also increases. In contrast, as the thickness of the transflective electrode becomes thicker, light transmittance decreases.

The transflective electrode and the reflective electrode may have a multilayer structure that includes a metal layer made of a metal or an alloy thereof and a transparent conductive oxide layer laminated on the metal layer.

According to one embodiment, the wall display system may have a dual emission structure, and thus light may be emitted in directions of the pixel electrode 211 and the common electrode 213 so that an image is displayed. Therefore, the pixel electrode 211 and the common electrode 213 may be formed as a transmissive or transflective electrode.

The sealing members 250 may be disposed on the common electrode 213. The sealing member 250 may have a thin film encapsulation structure in which one or more inorganic layers and one or more organic layers are alternately laminated.

The coating layer 260 may be disposed on the substrate 110 and one surface of the sealing member 250. The coating layer 260 may include at least one selected from the group consisting of a water-proof coating layer 261 and a heat-proof coating layer 262. The coating layer 260 may prevent penetration of water or heat from surrounding environment, thereby reducing damage to the display unit 100.

The water-proof coating layer 261 may be made of a polymer material that has transparency. The water-proof coating layer 261 may be made of, for example, polyester or parylene. The water-proof coating layer 261 may be coated by a thermal diffusion deposition method at room temperature or may be formed by bonding a film having water proof characteristic. In addition, water-proof coating materials generally used in the art may also be applied to embodiments of the inventive concept.

The heat-proof coating layer 262 may be made of materials that have transparency and high thermal conductivity. For example, the heat-proof coating layer 262 may be made of a graphite sheet or an acrylic sheet. In addition, heat-proof coating materials generally used in the art may also be applied to embodiments of the inventive concept. The touch screen panel 270 may be disposed on the coating layer 260.

A user may input a memo or an image by utilizing the touch screen panel 270. For instance, if the user input an analog signal to the display unit 100 utilizing the hands or a stylus pen, the controller 500 may recognize a corresponding coordinate on the display unit 100, convert the corresponding coordinate to a digital signal, and output the digital signal to the display unit 100. In addition to the above method, a memo or an image can be input to the display unit 100 by a user utilizing the hands or the stylus pen according to known image processing methods. Besides, a user can, of course, input a memo or an image utilizing conventional input tools such as a mouse or keyboard.

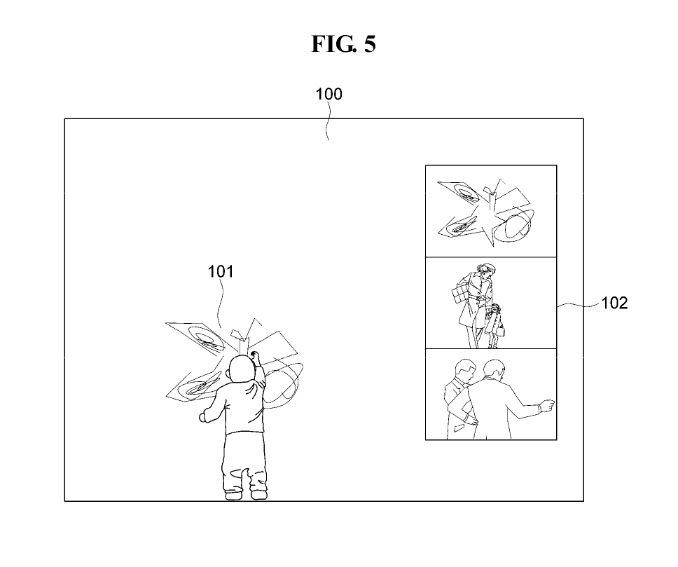

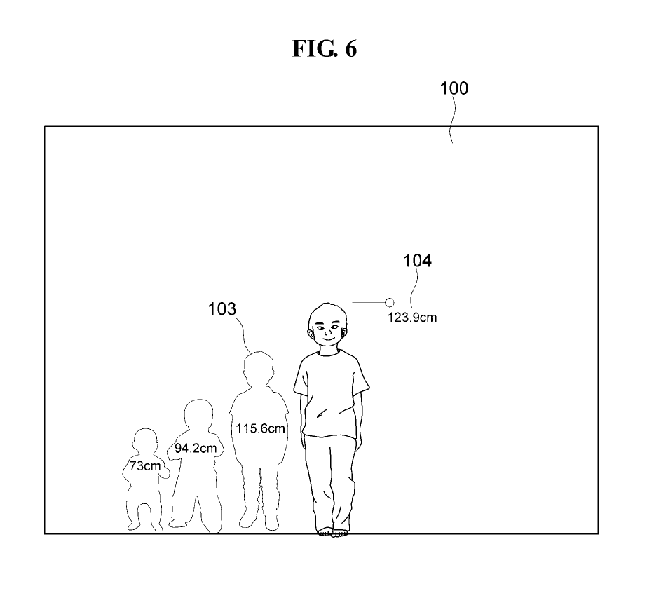

FIGS. 5 and 6 provide examples of application of a wall display system according to an embodiment of the inventive concept.

Referring to FIG. 5, a user may input a memo or an image 101 to the display unit 100 utilizing the hands or a dedicated pen such as a stylus pen, and the input memo or image 101 may be stored or output to the display unit 100. Because children at home like to paint or draw (e.g., scribbles) on the wall, the house is in an untidy state (or in a mess). However, the wall display system according to one embodiment may allow the children to freely paint or draw a picture corresponding to the image 101 on the display unit 100 and may store or edit the image 101 so as to apply the image 101 to a frame 102 or a wallpaper design. Further, the wall display system may apply animation effects to the image 101 which is drawn by the children, thereby increasing children's interest, stimulating imagination, and recording childhood memories. In addition, the wall display system may edit an image transmitted from the smart device so that the edited image may be used for the frame 102 or the wallpaper design.

Referring to FIG. 6, the wall display system according to one embodiment may enable a user to record children's growth and also to compare the children's growth. For instance, a child may stand before the display unit 100 of the wall display system that is in a state of a growth recording mode, and then the height of the child may be automatically measured 104 and the measured height may be compared with the previous records. In this case, a photo 103 or a video taken when the height was measured may be output to the display unit 100 at the same time.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the scope and spirit of the inventive concept.

What is claimed is:

1. A wall display system comprising:
a display unit mounted on the entire surface of a wall or a part of the wall surface, the display unit being configured to reproduce sound or images;
a camera and microphone configured to detect motion and sound of a user, respectively; and
a controller configured to receive image signals and sound signals output from the camera and microphone, respectively, and to transmit the image signals to the display unit.

2. The wall display system of claim 1, wherein the controller operates the display unit and the microphone according to the image signals output from the camera.

3. The wall display system of claim 1, wherein the controller operates the display unit and the camera according to the sound signals output from the microphone.

4. The wall display system of claim 1, further comprising a storage unit configured to store the image signals and sound signals output from the camera and microphone.

5. The wall display system of claim 4, wherein the controller simultaneously outputs image data or sound data, which is stored at different times, to the display unit.

6. The wall display system of claim 4, wherein the controller simultaneously outputs previously input image data or sound data stored in the storage unit and current input image data or sound data to the display unit.

7. The wall display system of claim 1, further comprising a communication unit configured to connect the controller to a smart device in a wired or wireless manner.

8. The wall display system of claim 7, wherein the controller outputs image data or sound data input from the smart device through the communication unit to the display unit.

9. The wall display system of claim 1, wherein the display unit comprises:
a substrate;
a driving circuit unit on the substrate;
a display element unit on the driving circuit unit;
a sealing member on the display element unit; and
a touch screen panel disposed on at least one of the substrate and the sealing member.

10. The wall display system of claim 9, wherein the controller operates the display unit utilizing a touch signal input through the touch screen panel.

11. The wall display system of claim 9, wherein the substrate comprises any one of glass, tempered glass, and transparent plastic.

12. The wall display system of claim 11, wherein the transparent plastic comprises at least one material selected from the group consisting of Kapton®, polyethersulphone (PES), polycarbonate (PC), polyimide (PI), polyethyleneterephthalate (PET), polyethylenenaphthalate (PEN), polyacrylate (PAR), and fiber reinforced plastic (FRP).

13. The wall display system of claim 9, wherein the driving circuit unit comprises a thin film transistor layer.

14. The wall display system of claim 13, wherein the thin film transistor layer comprises an oxide semiconductor.

15. The wall display system of claim 14, wherein the thin film transistor layer comprises a transparent electrode material.

16. The wall display system of claim 15, wherein the transparent electrode material comprises a transparent conducting oxide (TCO).

17. The wall display system of claim 16, wherein the transparent conducting oxide (TCO) comprises at least one selected from the group consisting of indium tin oxide (ITO), indium zinc oxide (IZO), antimony tin oxide (ATO), aluminum zinc oxide (AZO), zinc oxide (ZnO), and mixtures thereof.

18. The wall display system of claim 9, wherein the display element unit comprises an organic light emitting diode.
